(19) United States
(12) Patent Application Publication
(10) Pub. No.: US 2010/0110115 A1
(43) Pub. Date: May 6, 2010

(54) Frame Rate Control Method and Display Device Using the Same

(75) Inventors: Hung Li, Taipei City (TW); Chien-Yu Chan, Hsinchu City (TW); Jun-Ren Shih, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Raydium Semiconductor Corporation, Hsinchu (TW)

(21) Appl. No.: 12/612,040

(22) Filed: Nov. 4, 2009

(30) Foreign Application Priority Data
Nov. 6, 2008 (TW) 97142958

(51) Int. Cl. G09G 5/02; G09G 3/20

(52) U.S. Cl. 345/698; 345/55

(57) ABSTRACT

A frame rate control (FRC) method is provided for driving a number of pixels according to a number of pixels data. The pixels include a number of first color sub-pixels. In this method, the dithering process is performed to the pixels data in two frames according to two basic matrixes respectively. In one of the two frames, the numbers of the first color sub-pixels, driven by the positive pixel voltages and the negative pixel voltages and to which the dithering process has been performed, are the same in substantiality. Further, in the other of the two frames, the numbers of the first color sub-pixels, driven by the positive pixel voltages and the negative pixel voltages and to which the dithering process has been performed, are also the same in substantiality.

This application claims the benefit of Taiwan application Serial No. 97142958, filed Nov. 6, 2008, the subject matter of which is incorporated herein by reference.

### BACKGROUND OF THE INVENTION

1. Field of Invention

The invention relates in general to a frame rate control method and a display device using the same, and more particularly to a frame rate control method capable of avoiding frame glittering and a display device using the same.

2. Description of Related Art

The dithering process is one of the most commonly used image processing technology in the display industry. When using the dithering process technology, the display device achieves the display effect of 8-bit grey level by 6-bit pixel data. The display device adopts frame rate control (FRC) method to increase the grey level of 2 bits.

Referring to FIG. 1, an example of the FRC driving method is shown. In the present example, the FRC method is used for driving a pixel. According to the FRC driving method, when the pixel displays a grey level according to an original pixel data d0, the equivalent grey level value GL being displayed equals the sum of the grey levels displayed by four items of pixel data d1˜d4 of the four frames F1˜F4.

Thus, by performing the dithering process to the pixel data d0 through a pixel data (such as the original pixel data d0, d0=127) and the four adjacent frames F1˜F4, the pixel displays four different grey levels GL (such as the equivalent grey level value GL=127, 127.25, 127.5 or 127.75), such that the extra 2-bit grey level is available. However, frame glittering always occurs during the dithering process. Therefore, how to avoid the occurrence of frame glittering when the display device performs the dithering process to pixel data has become an imminent issue to be resolved in the display industry.

### SUMMARY OF THE INVENTION

The invention is directed to frame rate control (FRC) method and a display device using the same. According to the invention, the average voltage of the voltages received by the sub-pixels in a first frame is close to that received in a second frame. Thus, the average brightness of the display frames of the display panel will remain the same, hence avoiding frame glittering.

In some embodiments, a frame rate control method is provided for driving a number of pixels according to a number of pixels data. The pixels include a number of first color sub-pixels. The method includes the following steps. In a first frame, the dithering process is selectively performed to the pixel data according to a first basic matrix to generate a number of first FRC data, and a number of first FRC positive pixel voltages and a number of first FRC negative pixel voltages are outputted according to the first FRC data to drive at least a part of the pixels. In a second frame, the dithering process is selectively performed to the pixel data according to a second basic matrix to generate a number of second FRC data, and a number of second FRC positive pixel voltages and a number of second FRC negative pixel voltages are outputted according to the second FRC data to drive at least a part of the pixels. The second frame and the first frame are adjacent to each other.

In one of the above embodiments, in the first and the second frames, the numbers of the first color sub-pixels driven by the first and the second FRC positive pixel voltages respectively are substantially respectively equal to that driven by the first and the second FRC negative voltages respectively.

In another of the above embodiment, in the first and the second frames, the number of the first color sub-pixels driven by the FRC positive pixel voltage or the FRC negative pixel voltage is zero in substantiality.

In some other embodiments, a display device including a display panel, a timing controller, and a data driver is provided. The display panel includes a number of pixels, which include a number of first color sub-pixels. The timing controller, in a first frame, selectively performs the dithering process to a number of pixels data according to a first basic matrix to generate a number of first FRC data. The timing controller, in a second frame, further selectively performs the dithering process to the pixel data according to a second basic matrix to generate a number of second FRC data. The second frame and the first frame are adjacent to each other. The data driver outputs a number of first FRC positive pixel voltages and a number of first FRC negative pixel voltages according to the first FRC data to drive at least a part of the pixels. The data driver further outputs a number of second FRC positive pixel voltages and a number of second FRC negative pixel voltages according to the second FRC data to drive at least a part of the pixels.

In one of the above embodiments, in the first and the second frames, the number of the first color sub-pixels driven by the first and the second FRC positive pixel voltages are substantially equal to that driven by the first and the second FRC negative voltages respectively.

In another of the above embodiments, in the first and the second frames, the number of the first color sub-pixels driven by the FRC positive pixel voltages or the FRC negative pixel voltages is zero in substantiality.

The invention will become apparent from the following detailed description of preferred but non-limiting embodiments. The following description is made with reference to the accompanying drawings.

### BRIEF DESCRIPTION OF THE DRAWINGS

FIG. 1 shows an example of the FRC driving method;

FIG. 2 shows a block diagram of a display device according to a preferred embodiment of the invention;

FIG. 3 shows a flowchart of an FRC driving method according to a first embodiment of the invention;

FIGS. 4A and 4B respectively show an example of the pixels driven by pixel voltages of different polarities according to the basic matrixes M1 and M2 in two frames according to a first embodiment of the invention;

FIGS. 5A˜5C show examples of the wave pattern of average voltage of the pixel voltage received by all pixels when the display device, using the same original pixel data, executes the conventional FRC driving method, the FRC driving method of the first embodiment of the invention, and the FRC driving method of the second embodiment of the invention, respectively;

FIGS. 6A and 6B respectively show another examples of the pixels being driven by the pixel voltage of different polarities according to two basic matrixes M1 and M2 in two frames according to a first embodiment of the invention;

FIGS. 7A, 7B, 8A and 8B respectively show another examples of the pixels being driven by the pixel voltage of different polarities according to two basic matrixes M1 and M2 in two frames according to a second embodiment of the invention; and

FIGS. 9A and 9B respectively show the other two basic matrixes used by the timing controller according to a second embodiment of the invention.

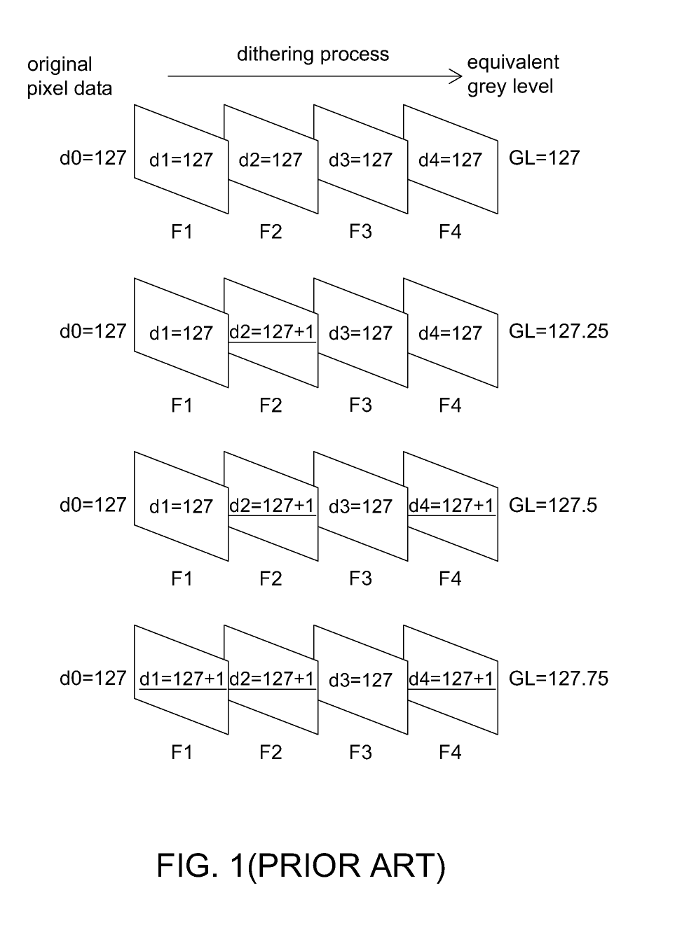

### DETAILED DESCRIPTION OF THE INVENTION

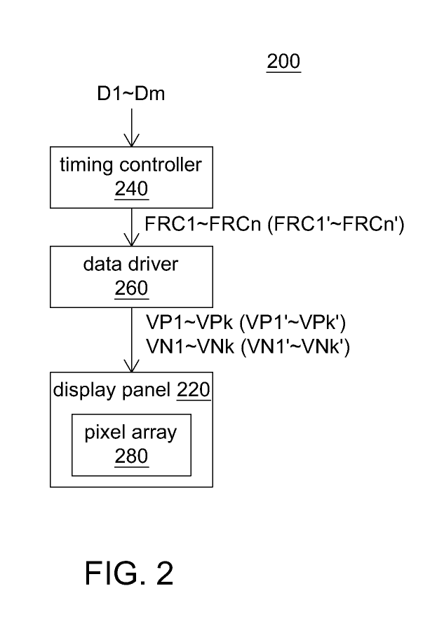

Referring to FIG. 2, a block diagram of a display device according to a preferred embodiment of the invention is shown. The display device 200 includes a display panel 220, a timing controller 240, and a data driver 260. The display panel 220 includes a pixel array 280, which includes a number of pixels P1˜Pm each including a number of different-colored sub-pixels. The display device 200 executes frame rate control (FRC) method so that the timing controller 240 and data driver 260 sequentially and selectively performs the dithering process to a number of pixels data D1˜Dm according to two basic matrixes and outputs a voltage to drive the pixels P1˜Pm of the display panel 220 to display frames. The display device 200 and the FRC driving method executed thereby are elaborated in two embodiments below.

### First Embodiment

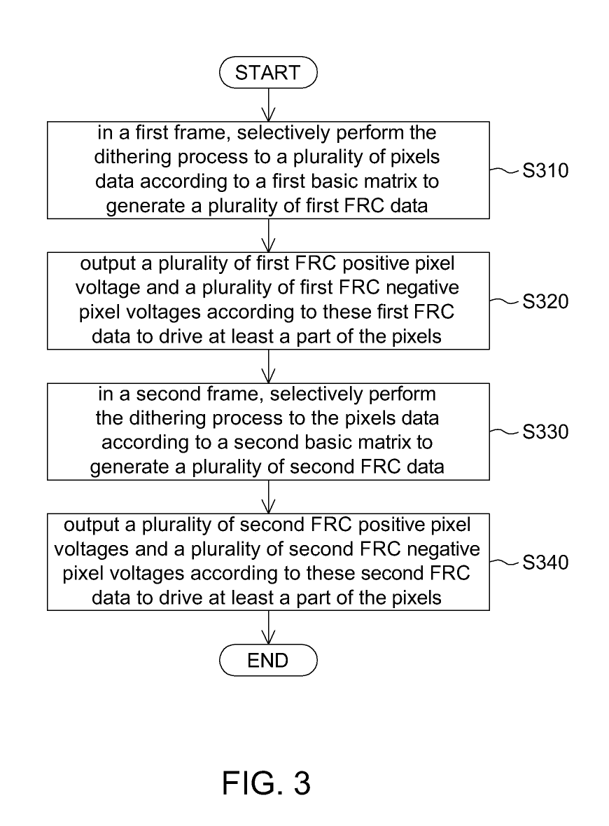

Referring to FIG. 3, a flowchart of an FRC driving method according to a first embodiment of the invention is shown. The method begins at step S310, in a first frame, the timing controller 240 selectively performs the dithering process to the pixels data D1˜Dm according to a first basic matrix to generate a number of FRC data FRC1˜FRCn. Next, the method proceeds to step S320, the data driver 260 outputs a number of FRC positive pixel voltages VP1˜VPk and a number of FRC negative pixel voltages VN1˜VNk according to these FRC data FRC1˜FRCn to drive at least a part of the pixels P1˜Pm.

Then, the method proceeds to step S330, in a second frame, the timing controller 240 selectively performs the dithering process to the pixels data D1˜Dm according to a second basic matrix to generate a number of FRC data FRC1′˜FRCn′. After that, the method proceeds to step S340, the data driver 260 outputs a number of FRC positive pixel voltages VP1′˜VPk′ and a number of FRC negative pixel voltages VN1′˜VNk′ according to these FRC data FRC1′˜FRCn′ to drive at least a part of the pixels P1˜Pm. The second frame and the first frame, which are adjacent to each other, sequentially display two frame borders of two frames.

In the first embodiment, to avoid frame glittering occurring to the display panel 220 in the first and the second frames, at least a part of the pixels P1˜Pm being driven must meet the following conditions. In the first frame, the number of the first color sub-pixels of the pixels P1˜Pm driven by the FRC positive pixel voltages VP1˜VPk is substantially equal to that driven by the FRC negative voltages VN1˜VNk. Moreover, in the second frame, the number of the first color sub-pixels driven by the FRC positive pixel voltages VP1′˜VPk′ is substantially equal to that driven by the FRC negative pixel voltages VN1′˜VNk′. The above conditions are also applicable to the second color sub-pixels of the pixels P1˜Pm and are not repeated here.

The calculation of these numbers is exemplified by the calculation of the numbers of RGB sub-pixels in a first example and a second example below.

The first frame: +RD, +GD, and +BD are respectively defined as the numbers of the red, the green, and the blue sub-pixels driven by the FRC positive pixel voltages VP1˜VPk; −RD, −GD, and −BD are respectively defined as the numbers of the red, the green, and the blue sub-pixels driven by the FRC negative pixel voltages VN1˜VNk.

The second frame: +RD′, +GD′, and +BD′ are respectively defined as the numbers of the red, the green, and the blue sub-pixels driven by the FRC positive pixel voltages VP1′˜VPk′; −RD′, −GD′, −BD′ are respectively defined as the numbers of the red, the green, and the blue sub-pixels driven by the FRC negative pixel voltages VN1′˜VNk′.

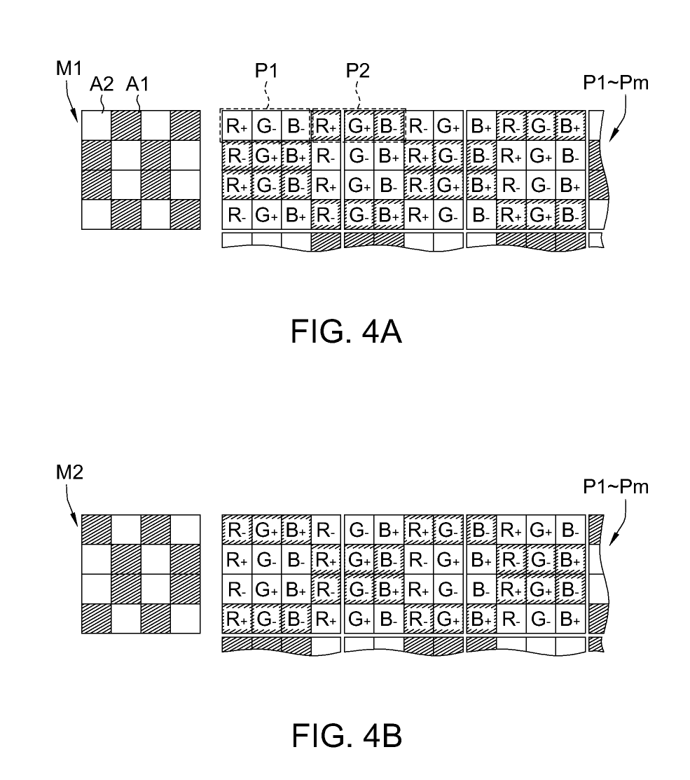

The first example is elaborated below. As indicated in FIGS. 4A and 4B, the pixels P1˜Pm are the RGB sub-pixels R, G and B arranged in stripes. The data driver 260 performs polarity conversion by way of two-dot inversion, wherein, the dots correspond to the sub-pixels. The basic matrixes M1 and M2 are stored in the timing controller 240 for example. Each of the basic matrixes M1 and M2 has 4×4 dots for example, and includes a number of dithering-processing dots (the boxes with slash lines) and a number of non-dithering-processing dots (the blank boxes). The timing controller 240 will perform the dithering process to the pixel data received by the sub-pixel corresponding to the dithering-processing dots but not to the pixel data received by the sub-pixel corresponding to the non-dithering-processing dots.

In the first example, the processing dots of the two basic matrixes M1 and M2 are pixels based and correspond to the pixels P1˜Pm. That is, in FIG. 4A, the non-dithering-processing dot A2 corresponds to the RGB sub-pixels of the pixel P1, and the dithering-processing dot A1 corresponds to the RGB sub-pixels of the pixel P2. Thus, in the first frame, the dithering process will not be performed to the pixel data received by the RGB sub-pixel of the pixel P1 but will be performed to the pixel data received by the RGB sub-pixel of the pixel P2. Further, the basic matrix M1 having 4×4 dots corresponds to 48 sub-pixels as indicated in FIG. 4A. Likewise, the corresponding relationships between the basic matrix M2 and the pixels P1˜Pm in FIG. 4B are similar to that in FIG. 4A.

As indicated in FIG. 4A, in the first frame, the value of +RD of 48 sub-pixels is 4, and the value of −RD is 4 as well. Likewise, the values of +GD and −GD are both 4, and the values of +BD and −BD are 4 as well. As indicated in FIG. 4B, in the second frame, the value of +RD′ of the 48 sub-pixels is 4, and the value of −RD′ is 4 as well. Likewise, the values of +GD′ and −GD′ are both 4, and the values of +BD′ and −BD′ are also 4 as well.

In the first frame and the second frame, the number of the color sub-pixels R, G and B driven by the FRC positive pixel voltages are respectively the same with that driven by the FRC negative pixel voltages. Therefore, the occurrences of glittering are effectively reduced.

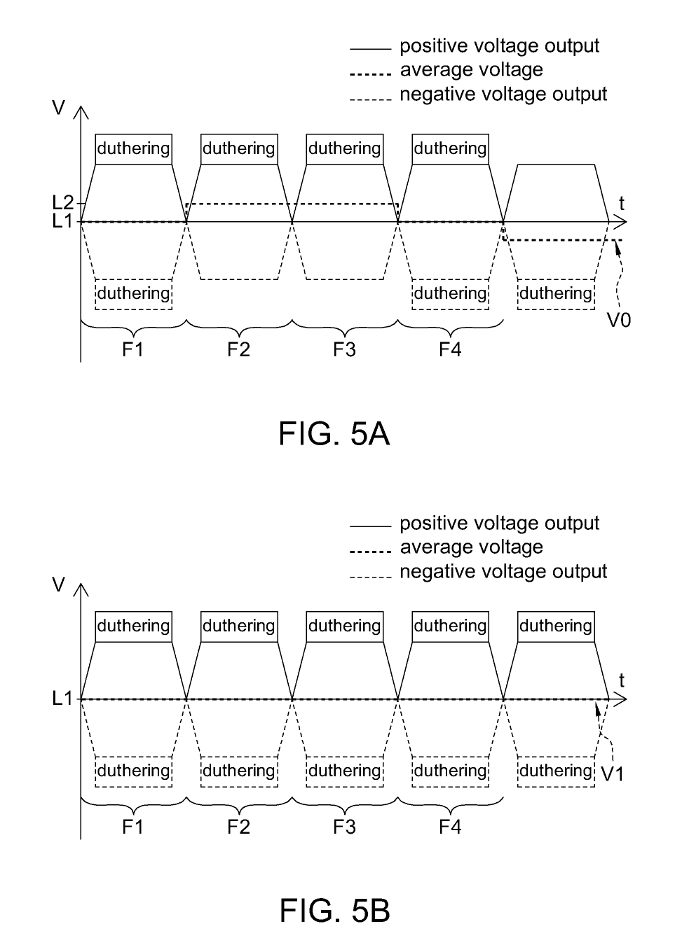

As indicated in FIGS. 5A and 5B, the box designated by “dithering” denotes the voltage decreased or increased during the dithering process. In practical application, the applicant finds out that when performing the dithering process to the pixel data, the occurrence of glittering can be avoided if the average voltages in the first frame and the second frame are substantially close to each other.

That is, in the first frame F1 of FIG. 5A, if the numbers of the positive and the negative pixels to which the dithering process is performed are the same, then the average voltage V0 equals level L1 in the first frame F1. In the second frame F2, if the number of the negative pixels to which the dithering process is performed is less than the number of the positive pixels to which the dithering process is performed, then the average voltage V0 equals level L2 in the second frame F2. There is a difference between the two levels L1 and L2. As the average voltage corresponds to the average brightness of the display frames, the average brightness of the display frames of the display panel 220 will change and result in frame glittering.

Correspondingly, in FIG. 5B, the numbers of the positive and the negative pixels to which the dithering process are the same in the first frame F1, and the numbers of the positive and the negative pixels to which the dithering process are the same in the second frame F2 as well, so the levels of the average voltages V1 in the two frames F1 and F2 are substantially close to each other. For example, the average voltages V1 in the two frames F1 and F2 are both level L1. Therefore, the frames displayed in the two frames F1 and F2 of the display panel 220 substantially have the same average brightness, hence avoiding the occurrence of frame glittering.

The explanations of the second example are given below. The second example differs the first example in that each processing dot of the two basic matrixes M1 and M2 is sub-pixel-based and corresponds to the pixels P1˜Pm.

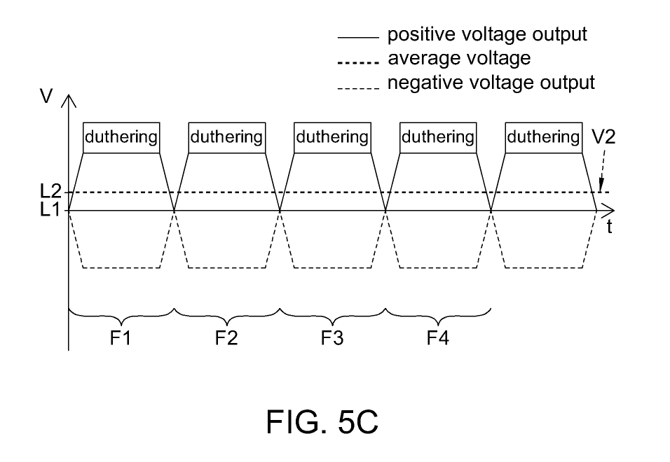

As indicated in FIG. 6A, in the first frame, the value of +RD of 48 sub-pixels is 4, and the value of −RD is 4 as well. Likewise, the values of +GD and −GD are both 4, and the values of +BD and −BD are 4 as well. As indicated in FIG. 6B, in the second frame, the value of +RD′ of the 48 sub-pixels is 4, and the value of −RD′ is 4 as well. Likewise, the values of +GD′ and −GD′ are both 4, and the values of +BD′ and −BD′ are also 4 as well.

Therefore, in the second example, the occurrence of frame glittering can be effectively avoided.

### Second Embodiment

The second embodiment differs with the first embodiment in that for the display panel 220 to display frames with stable brightness, at least a part of the pixels P1˜Pm being driven must meet the following conditions. In the first and the second frames, the number of the first color sub-pixels driven by the FRC positive pixel voltage VP1˜VPk and VP1′˜VPk′ is zero in substantiality, or the number of the first color sub-pixels driven by the FRC negative voltage VN1˜VNk and VN1′˜VNk′ is zero in substantiality. The above conditions are also applicable to the second color sub-pixel, and are not repeated here.

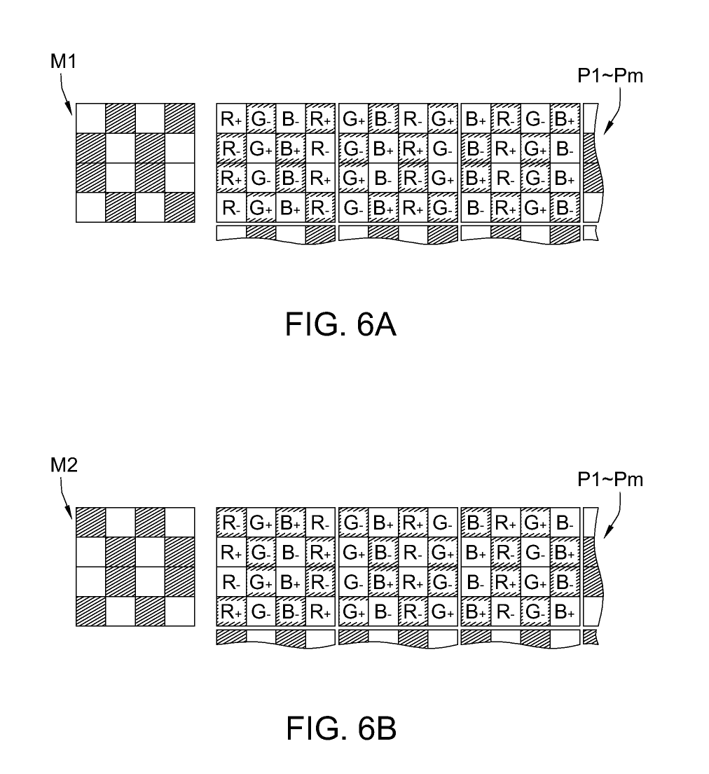

Let the first example be taken for example. Referring to FIGS. 7A and 7B. Like FIGS. 4A and 4B, in FIGS. 7A and 7B, the processing dots of the two basic matrixes M1 and M2 are pixels based and correspond to the pixels P1˜Pm.

As indicated in FIG. 7A, in the first frame, the value of −GD of the 48 sub-pixels is 0. As indicated in FIG. 7B, in the second frame, the value of −GD′ of the 48 sub-pixels is 0 as well. By the same token, in the first and the second frames, the number of the green sub-pixels G driven by the FRC negative pixel voltages is zero in substantiality. Alternatively, the number of the blue sub-pixels B or the red sub-pixels or R driven by the FRC negative pixel voltages is also zero in substantiality. Thus, the occurrence of frame glittering can be effectively avoided.

Also referring to FIG. 5C. As the numbers of the sub-pixels driven by the FRC negative pixel voltages is substantially zero in both the first frame F1 and the second frame and F2, the average voltage V2 of the two frames F1 and F2 will have similar level such as level L2, hence avoiding the occurrence of frame glittering.

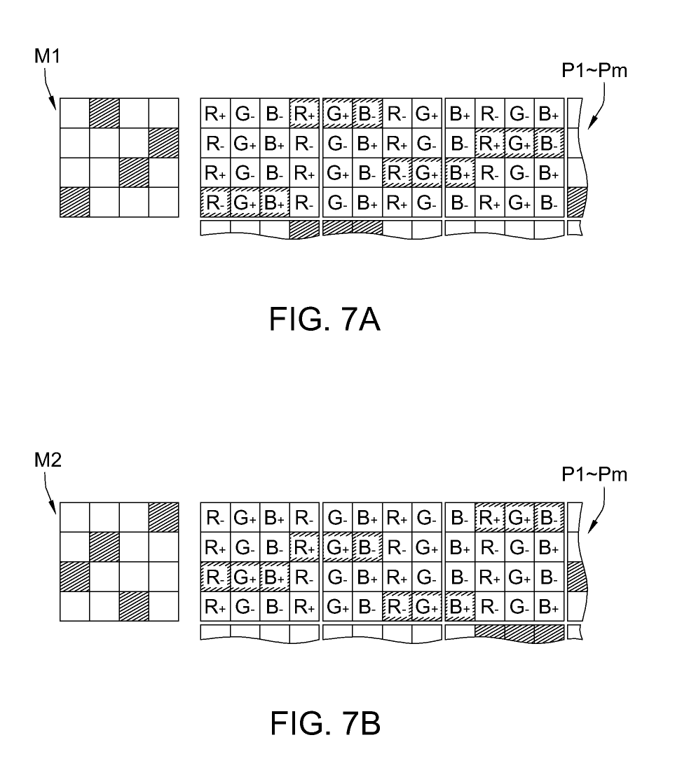

Let the second example be taken for example. The second example differs with the first example in that each processing dot of the two basic matrixes M1 and M2 is sub-pixel based and corresponds to the pixels P1˜Pm as indicated in FIGS. 8A and 8B. Likewise, in the second example, the numbers of the sub-pixels R, G and B driven by the FRC negative pixel voltages can be zero in substantiality. Thus, the occurrence of frame glittering can be avoided.

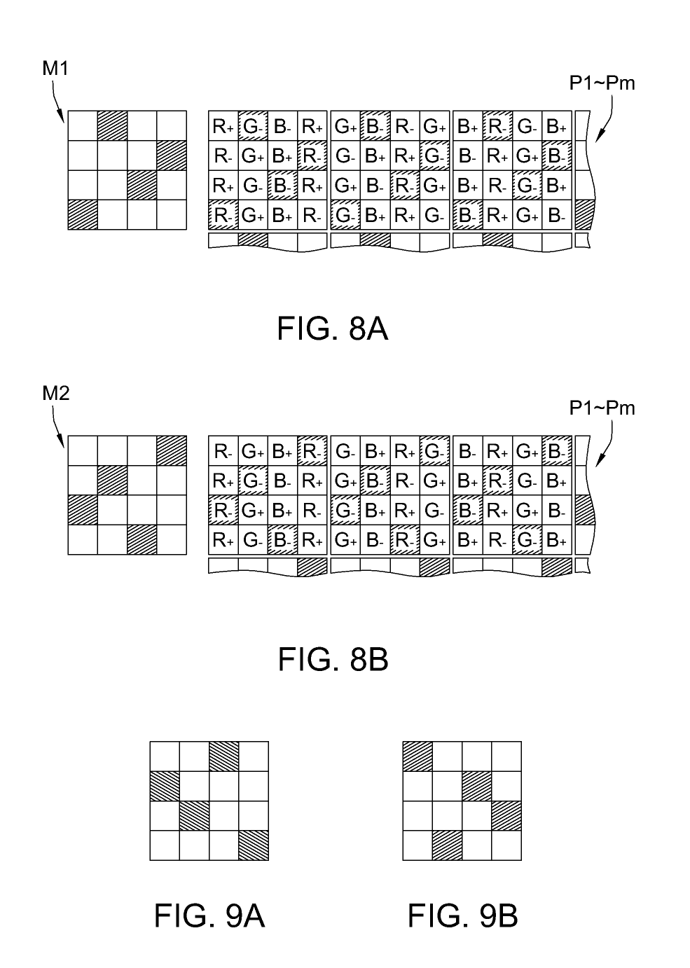

The applicant further discloses another two basic matrixes M3 and M4 as indicated in FIGS. 9A and 9B. The other two basic matrixes M3 and M4 can be used in the second embodiment. Moreover, the second embodiment is exemplified by the example that the display device 200 outputs two frames according to two basic matrixes, but the second embodiment is not limited to the above exemplifications. The timing controller 240 can also perform the dithering process according to the four basic matrixes M1˜M4 to avoid the occurrence of frame glittering.

According to the display device 200 disclosed in the above embodiments of the invention, the display panel 220 includes the RGB sub-pixels R, G and B arranged in stripes, and the data driver 260 performs polarity conversion by way of two-dot inversion. However, the invention is not limited to the above exemplifications. Any designs using corresponding basic matrixes for enabling the display panel to have similar average voltage in adjacent frames so as to avoid the occurrence of frame glittering are within the scope of protection of the invention.

According to the FRC driving method and the display device using the same disclosed in the above embodiments of the invention, in two adjacent frames, the average voltages of the voltages received by the sub-pixels in the two adjacent frames are close to each other. Thus, the average brightness of the display frames of the display panel will remain the same, hence avoiding the occurrence of frame glittering.

While the invention has been described by way of example and in terms of a preferred embodiment, it is to be understood that the invention is not limited thereto. On the contrary, it is intended to cover various modifications and similar arrangements and procedures, and the scope of appended claims therefore should be accorded the broadest interpretation so as to encompass all such modifications and similar arrangements and procedures.

What is claimed is:

1. A frame rate control (FRC) method for driving a plurality of pixels according to a plurality of pixels data, wherein the pixels comprise a plurality of first color sub-pixels, and the method comprises:
in a first frame, selectively performing the dithering process to the pixels data according to a first basic matrix to generate a plurality of first FRC data and outputting a plurality of first FRC positive pixel voltage and a plurality of first FRC negative pixel voltages according to these first FRC data to drive at least a part of the pixels; and
in a second frame, selectively performing the dithering process to the pixels data according to a second basic matrix to generate a plurality of second FRC data and outputting a plurality of second FRC positive pixel voltages and a plurality of second FRC negative pixel voltages according to these second FRC data to drive at least a part of the pixels, wherein the second frame and the first frame are adjacent to each other;
wherein, in the first frame, the number of the first color sub-pixels driven by the first FRC positive pixel voltages is substantially equal to that driven by the first FRC negative voltage;
wherein, in the second frame, the number of the first color sub-pixels driven by the second FRC positive pixel voltages is substantially equal to that driven by the second FRC negative pixel voltages.

2. The method according to claim 1, wherein, the pixels further comprises a plurality of second color sub-pixels;
wherein, in the first frame, the number of the second color sub-pixels driven by the first FRC positive pixel voltages is substantially the same with that driven by the first FRC negative voltages;
wherein, in the second frame, the number of the second color sub-pixels driven by the second FRC positive pixel voltages is substantially the same with that driven by the second FRC negative pixel voltages.

3. A frame rate control (FRC) method for driving a plurality of pixels according to a plurality of pixels data, wherein the pixels comprise a plurality of first color sub-pixels, and the method comprises:
in a first frame, selectively performing the dithering process to generate a plurality of first FRC data to the pixels data according to a first basic matrix and outputting a plurality of first FRC positive pixel voltage and a plurality of first FRC negative pixel voltages according to these first FRC data to drive at least a part of the pixels; and
in a second frame, selectively performing the dithering process to the pixels data according to a second basic matrix to generate a plurality of second FRC data and outputting a plurality of second FRC positive pixel voltages and a plurality of second FRC negative pixel voltages according to these second FRC data to drive at least a part of the pixels, wherein the second frame and the first frame are adjacent to each other;
wherein, in the first and the second frames, the number of the first color sub-pixels driven by the FRC positive pixel voltages is zero in substantiality, or the number of the first color sub-pixels driven by these FRC negative voltage pixel voltages is zero in substantiality.

4. The method according to claim 3, wherein, the pixels further comprises a plurality of second color sub-pixels;
wherein, in the first and the second frames, the number of the second color sub-pixels driven by the FRC positive pixel voltages is zero in substantiality or the number of the second color sub-pixels driven by the FRC negative voltage pixel voltages is zero in substantiality.

5. A display device, comprising:
a display panel comprising a plurality of pixels, which comprise a plurality of first color sub-pixels;
a timing controller used for selectively performing the dithering process to a plurality of pixels data according to a first basic matrix to generate a plurality of first FRC data in a first frame and selectively performing the dithering process to the pixels data according to a second basic matrix to generate a plurality of second FRC data in a second frame, wherein the second frame and the first frame are adjacent to each other; and
a data driver used for outputting a plurality of first FRC positive pixel voltages and a plurality of first FRC negative pixel voltages according to these first FRC data to drive at least a part of the pixels and outputting a plurality of second FRC positive pixel voltages and a plurality of second FRC negative pixel voltages according to these second FRC data to drive at least a part of the pixels;
wherein, in the first frame, the number of the first color sub-pixels driven by the first FRC positive pixel voltages is substantially equal to that driven by the first FRC negative voltages;
wherein, in the second frame, the number of the first color sub-pixels driven by the second FRC positive pixel voltages is substantially equal to that driven by the second FRC negative pixel voltages.

6. The display device according to claim 5, wherein, the pixels further comprises a plurality of second color sub-pixels;
wherein, in the first frame, the number of the second color sub-pixels driven by the first FRC positive pixel voltages is substantially equal to that driven by the first FRC negative voltages;
wherein, in the second frame, the number of the second color sub-pixels driven by the second FRC positive pixel voltages is substantially equal to that driven by the second FRC negative pixel voltages.
